(19) United States
(12) Patent Application Publication
(10) Pub. No.: US 2017/0308906 A1
(43) Pub. Date: Oct. 26, 2017

(54) Systems and Methods For Processing Vehicle Permits, Titles, Registrations, and Liens Using A Hub Configuration

(71) Applicant: eDealer Services , LLC, Phoenix, AZ (US)

(72) Inventor: Jonathan McCauley, Chandler, AZ (US)

(21) Appl. No.: 15/134,132

(22) Filed: Apr. 20, 2016

(51) Int. Cl. G06Q 30/00; G06Q 20/10; G06Q 20/40; G06Q 50/26

(52) U.S. Cl. CPC G06Q 30/018; G06Q 50/26; G06Q 20/10; G06Q 20/407

(57) ABSTRACT

Systems and methods are provided for updating a vehicle record maintained in an MVD database through the steps of: issuing a temporary registration permit (TRP) at a dealer; issuing a title and a registration at a fiduciary; recording a lien associated with the title; and releasing the lien.

### TECHNICAL FIELD

The present invention relates, generally, to improved systems and methods for processing vehicle permits, titles, registrations, and liens and, more particularly, to an on-line platform for implementing a hub configuration in which a trusted third party facilitates the foregoing administrative functions on behalf of a government entity.

### BACKGROUND

State motor vehicle departments (MVDs) are charged with establishing and maintaining databases of vehicle records and their owners. This involves issuing temporary permits when a new or used car is purchased, issuing registrations, license plates, and titles, as well as recording, releasing, and correcting liens for vehicles financed through lenders (typically banks). These processes are document intensive, and require customer service personnel to provide information and assistance to dealers, lenders, customers, and service providers. Presently known systems are cumbersome and are not well suited to efficiently coordinating activities among the various stakeholders.

Before leaving a dealer's lot upon purchasing a new or used vehicle, a temporary registration permit (TRP) is often required. The TRP typically expires after a predetermined time period (e.g., 45 days), by which time a registration and a license plate must be secured. (See, for example, the “eTRP DEALER USER GUIDE” and the “eTRP ADOT User Guide” available at www.ADAA.com, the entire contents of which are hereby incorporated herein). In many jurisdictions this initial 45 day period may be extended via a subsequent 30 day permit. In this context, the process of “growing up” a vehicle record refers to the Department of Motor Vehicles (DMV) processing the TRP when the car is initially sold, through the title and registration process. Typically, the DMV monitors a vehicle's record as it grows up, and alerts stakeholders if a critical step is not taken within the statutory framework. Dealers often use dealer management system (DMS) software applications to track the documentation from initial purchase through the permit, title, and registration process. Currently known DMS vendors include Reynolds & Reynolds, ADP, Autosoft, Infinet, and Arcona.

To initiate the TRP application process during the purchase of a new or used vehicle, the DMS system uses the vehicle identification number (VIN) to interrogate the DMV database, also referred to herein as the DMV mainframe, which returns the vehicle make, model and year. The dealer finance clerk or sales clerk then enters the vehicle color into the application. The dealer then collects and merges owner information with the vehicle information and prints TRP if both owner and vehicle pass scrutiny (vehicle not stolen, owner passes background check for unpaid child support or other metrics from the DMV database).

In a typical statutory paradigm, if a dealer files the application for title and license within 30 days from the issuance of the TRP, the dealer and lender are insulated from financial liability if the purchaser files bankruptcy after taking possession of the recently purchased vehicle. Accordingly, the dealer is incented to complete the application for title and registration, and file it with the DMV, within 30 days from issuance of the TRP. For this and other reasons, many states have adopted a “hub” configuration, whereby a trusted third party entity, also referred to as a fiduciary, is statutorily authorized to undertake predefined administrative actions on behalf of the state. Consequently, when a fiduciary receives an application for title and registration as custodian for DMV within the 30 day time period, the dealer is protected in bankruptcy as if the application had actually been received by MVD.

Once the title and registration are processed, an electronic lien is recorded in the MV database, with parallel records maintained by the fiduciary. When the lien is paid off, the lender, either directly or via a lien service provider, informs MVD and requests that the lien be released. If desired, a printed copy of the title may be mailed to the title owner before the lien is satisfied (in which case the title notes the lien holder), or after the lien is satisfied (in which case the title does not reflect a lien holder).

Presently known techniques for managing vehicle TRPs, titles, registrations, and liens are cumbersome and time consuming. Systems and methods are thus needed which overcome these limitations. Various desirable features and characteristics will also become apparent from the subsequent detailed description and the appended claims, taken in conjunction with the accompanying drawings and this background section.

### BRIEF SUMMARY

The present invention provides systems and methods for designating a fiduciary to perform various administrative functions on behalf of the state MVD. The fiduciary may be implemented in the form of one or more internet portals configured to facilitate limited access to the MVD database by dealers and service providers, acting on behalf of lenders, to perform predetermined tasks associated with TRPs, titles, registrations, and liens, as described in greater detail below. In this way, the administrative burden is shifted from the state or other governmental entity to the private sector without compromising the security of the underlying vehicle and owner related records.

In one embodiment, an integrated software based-system effectively integrates a variety of functions including one or more of: i) issuing temporary vehicle registrations and operating permits; ii) issuing license plates and permanent registrations; and ii) facilitating lien releases once the loan used to finance the vehicle is paid off by the borrower.

Various other embodiments, aspects and features are described in greater detail below.

### BRIEF DESCRIPTION OF THE DRAWING FIGURES

Exemplary embodiments of the present invention will hereinafter be described in conjunction with the appended drawing figures, wherein like numerals denote like elements, and:

FIG. 1 is a screen shot of an exemplary home page of an internet portal operated by an authorized third party fiduciary on behalf of a state MVD in accordance with various embodiments;

FIG. 2 is a schematic block diagram illustrating a plurality of dealers connected to a single TRP hub in accordance with various embodiments;

FIGS. 3-7 are screen shots of eTRP web pages in accordance with various embodiments;

FIG. 8 is an eTRP title and registration template in accordance with various embodiments;

FIG. 9 is a schematic block diagram illustrating a plurality of dealers connected to a single eTitle hub in accordance with various embodiments;

FIGS. 10-13 are screen shots of eTitle web pages in accordance with various embodiments;

FIGS. 14-17 are exemplary collateral documents in accordance with various embodiments;

FIG. 18 is a schematic flow diagram illustrating how titles without liens are to purchasers, and how electronic liens are recorded in accordance with various embodiments;

FIG. 19 is an exemplary ELT transaction message in accordance with various embodiments;

FIGS. 19 and 20 are schematic flow diagrams illustrating exemplary processes for releasing electronic liens in accordance with various embodiments;

FIGS. 22 and 23 are exemplary flow charts illustrating processes for correcting electronic liens in accordance with various embodiments; and

FIG. 24 is a sequence diagram illustrating the life of an electronic lien in accordance with various embodiments.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

I. The TRP, eTitle, and ELT Continuum

Various embodiments of the present invention relate to systems and methods for allowing a fiduciary, or trusted third party, to provide an automobile reseller, referred to herein as a dealer, with secure access to an MVD mainframe to facilitate the creation of TRPs, titles, and registrations. In addition, the fiduciary also facilitates access by service providers, on behalf of lenders, to the MVD mainframe to process liens. An integrated system which tracks the vehicle record maintained in the MVD mainframe from temporary permit, through title and registration, and finally through the lien release process when the loan is paid off, provides convenience and efficiencies to vehicle purchasers (customers), lenders, dealers, service providers, MVDs. This is particularly appropriate in those jurisdictions which have legislated or otherwise adopted a “hub” paradigm in which dealers and/or service providers are required to coordinate with a fiduciary in order to gain secure access to the DMV mainframe. In a typical hub configuration, the fiduciary hosts various applications either as a single integrated code base residing on a single server (or group of servers), or as a suite of software tools which together implement the various functions described herein.

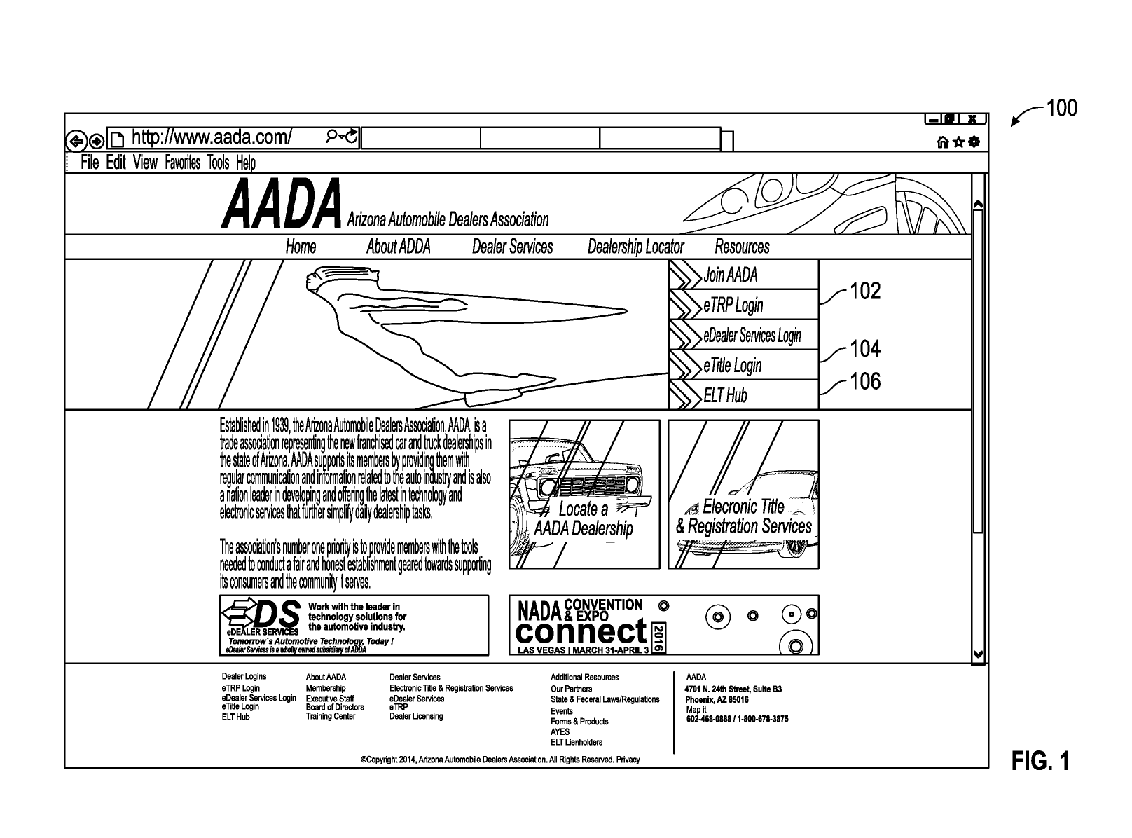

Referring now to FIG. 1, an exemplary web page 100 operated by an authorized third party fiduciary includes a plurality of tools including, for example, a temporary permit application (eTRP) 102, a title and registration application (eTitle) 104, and an electronic lien and title application (ELT) 106. These three functional modules, and their interrelationship, are described in greater detail below.

In a typical use case, a dealer finance department clerk uses the eTRP application to apply for a temporary registration for a vehicle at the time of purchase. A dealer title clerk subsequently uploads, using the dealer's DMS system, a batch file of funded vehicle records within a predetermined date range for importation to the eTitle application. The title clerk then logs onto the eTitle portal to process the funded deals, that is, to apply for titles and registrations for the funded vehicles. To facilitate the uploading of batch files from various DMS systems, the eTitle application may include an administrative tool (e.g., a software application) for mapping files from a DMS format to an eTitle format, as described below. A processing clerk, also referred to herein as a processor and typically employed by the fiduciary, then logs into the eTitle portal using a different permission set and completes the title and registration application process. Those skilled in the art will appreciate that in order to log into MVD mainframe as a 3d party vendor (fiduciary), the fiduciary may require a state issued resource access control facility (RACF) license, certification, or authentication.

In an embodiment, a processor (the fiduciary analog to a dealer title clerk) uses the eTitle system to assign a plate number from a block of sequentially numbered plates retrieved from a secure vault, and to obtain a title also retrieved from a secure vault. The processor sends the electronic files corresponding to the funded deals to MVD instructing MVD to update MVD's mainframe records, whereupon the vehicle record is fully “grown up.” MVD then furnishes a title number to the fiduciary. The processor then mails license plate, registration, and title (if no lien) to owner; if there is a lienholder, electronic title bearing the lien holder is sent to the lender or, alternatively, to a service provider on behalf of the lender. Once the loan is paid off, the lienholder notifies MVD to release the lien and, if permitted under state law, to also send a paper title to the owner.

The foregoing TRP, eTitle, and ELT modules will now be discussed in more detail in seriatim.

II. eTRP

In a typical use case, the eTRP application is invoked when financing has been approved and the customer (putative owner) is waiting to leave the dealer's lot with the vehicle which is typically registered in the dealer's name.

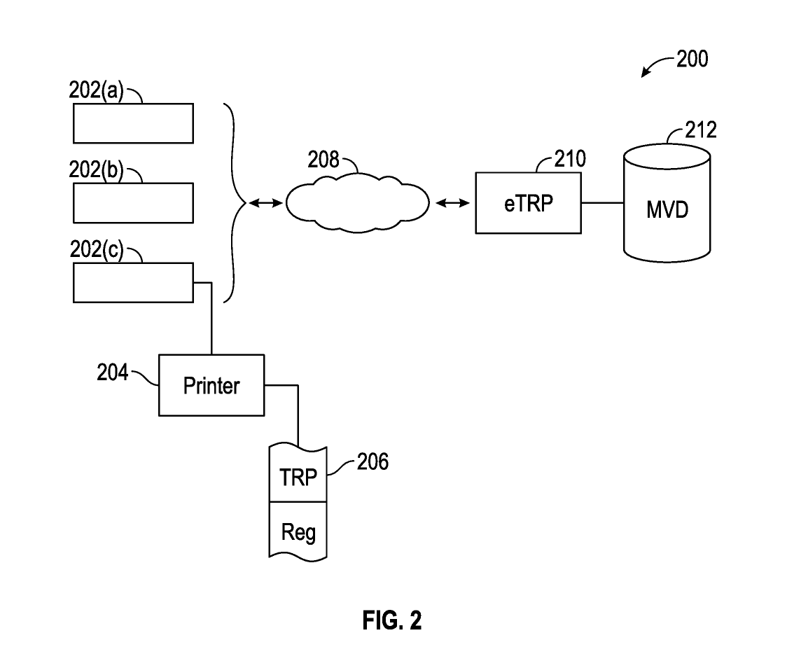

Referring now to FIG. 2, a “many-to-one” hub configuration 200 includes a plurality of dealer computers 202, each equipped with a DMS application and a printer for printing a temporary title and registration (TRP) document 206. Each dealer 202 is suitably configured to communicate over a network (e.g., the internet) 208 with a fiduciary 210 supporting an eTRP application portal configured to securely communicate with an MVD database 212.

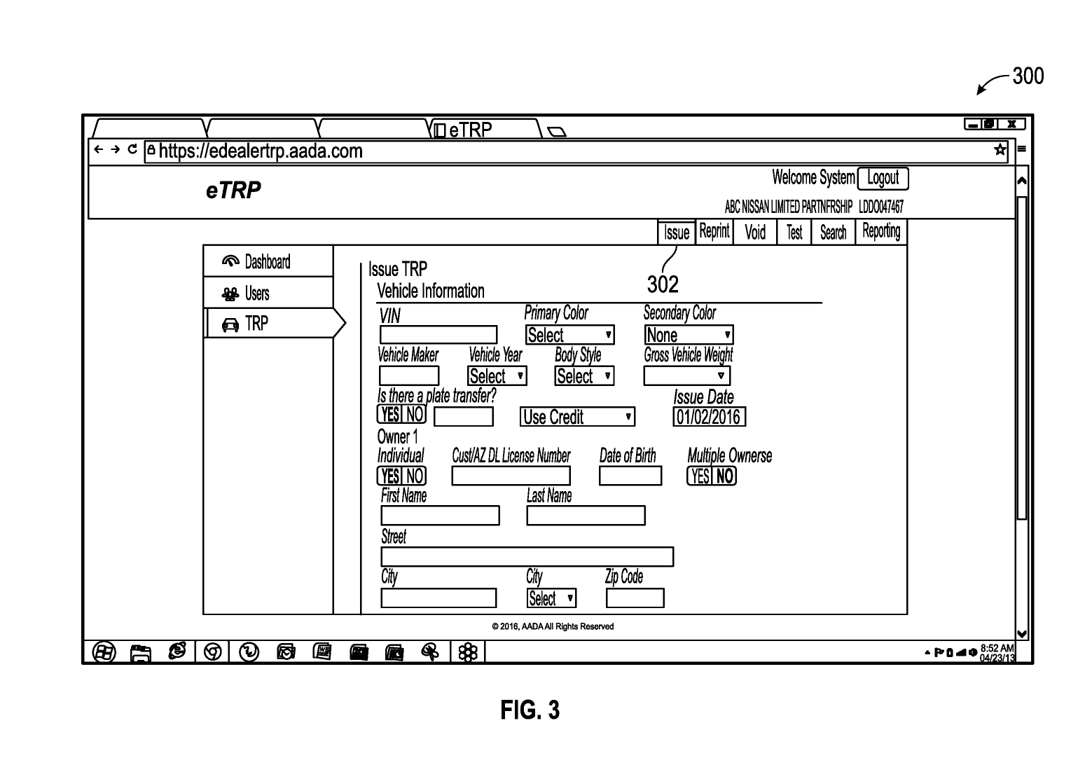

With reference to FIG. 3, after obtaining information regarding the customer and the purchased vehicle, the dealer finance clerk logs into the TRP portal. Following a real time or near real time confirmation that the dealer license is current and valid (e.g., through daily updates from MVD of current licensed dealers), the clerk selects the “Issue” icon 302 from a web page 300 to begin the process of issuing a TRP.

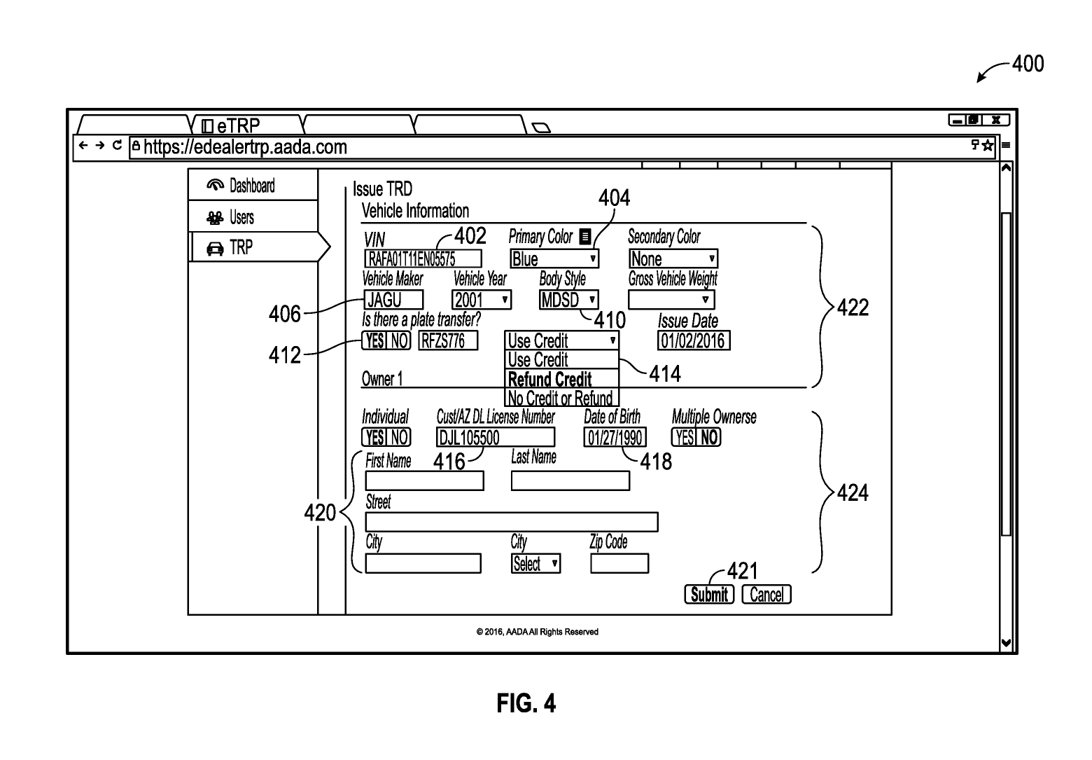

With continued reference to FIG. 2 and also referring now to FIG. 4, an on line TRP request template 400 includes a vehicle information section 422 and an owner section 424, with both sections simultaneously visible “above the fold” on a single web page; that is, all fields of both the vehicle information section 422 and the owner section 424 are simultaneously displayed without the user having to scroll the screen up or down. The vehicle information section 422 includes a vehicle identification number (VIN) field 402, a primary color field 404, a vehicle make field 406, a vehicle year field 408, a body style field 410, and a plate transfer query field 412. The owner section 424 includes a driver's license field 416, a date of birth (DOB) field 418, and a name and address portion 420.

When the dealer finance clerk enters the VIN into the VIN field 402, either by keying it in manually or copying and pasting from another location, the eTRP application 210 automatically uses the VIN to interrogate the MVD database 212. Based on the VIN, the MVD database returns the vehicle make, year, and body style, and automatically populates the corresponding fields in the TRP request template 400. In a preferred embodiment, the eTRP application operated by the fiduciary 210 immediately uses the VIN to interrogate the MVD database and populate template 400 when the user tabs or otherwise clicks out of the VIN field 402. Alternatively, the eTRP application determines when the VIN has been entered, for example by detecting the 17^{th} VIN character, and immediately searches the MVD database based on the VIN. The finance clerk may then select primary and/or secondary colors (e.g., if the vehicle is two-toned) from drop down menu(s).

In some jurisdictions the license plate remains with a vehicle after a used vehicle is purchased. In other jurisdictions, license plates remain the property of the previous owner of a sold vehicle. In those jurisdictions where the plate “stays with the owner,” field 412 of template 400 may be configured to ask the finance clerk if there is a plate and/or plate credit (e.g., unused or not yet expired plate fees) to transfer, preferably defaulting to “yes”. If plate credit is available from an existing plate, the application retrieves the amount of credit from the MVD database, and queries the user to select how to use the credit.

The owner information section 424 prompts the user to enter the owner's driver's license number (field 416) and DOB (field 418). Upon entering the driver's license number and DOB, the eTRP application interrogates the MVD database and Entering returns the owner's name and address. If either the driver's license or DOB fields change, MVD is re-queried to return name and address information for the new driver's license/DOB combination. Moreover, if “yes” is selected in response to the prompt “is there a plate to transfer,” the user may be prompted to enter a plate number, and the system may confirm that the plate number is associated with the driver's license number. Alternatively, entry of the driver's license number and DOB automatically queries the MVD mainframe to retrieve the owner's existing plate number, populates the plate number field, and determines whether and how much credit is available. In particular, the eTRP application may be configured to prompt the user to select whether the owner wants to use the plate credit toward the new plate, process a refund from MVD to the owner address listed on the TRP template, or transfer the plate to the newly purchased vehicle even if there is no plate credit, for example, if the owner wants to keep the same plate number.

In a primary use case, the plate number, DOB, and driver's license number must be entered before the system will return plate credit number and plate information, to prevent plate credit abuse. Alternatively, if the plate number is manually entered, the system may be configured to interrogate the MVD database and return the owner name, address, DOB, and driver's license number associated with that plate number.

In a preferred embodiment the system returns only one plate associated with the purchaser of a new or used vehicle, and does not return multiple plates if more than one plate is owned by the purchaser. Alternatively, the system may be configured to return multiple plate records, for example, in a drop down menu, and ask which plate and/or plate credit(s) the new owner would like to apply to the newly purchased vehicle. The system may be further configured to monitor, for example, using an RRS feed, each state's and/or county's rules on whether the plate goes with the owner or with the vehicle, and whether credit is available. Accordingly, in one use case, five fields are required to be entered in order to apply for a TRP: VIN, color, plate credit, driver's license number, and DOB. In the case where the default “use credit” for an existing plate is employed, a TRP may be obtained by manually populating only four fields, namely, VIN, color, driver's license number, and DOB.

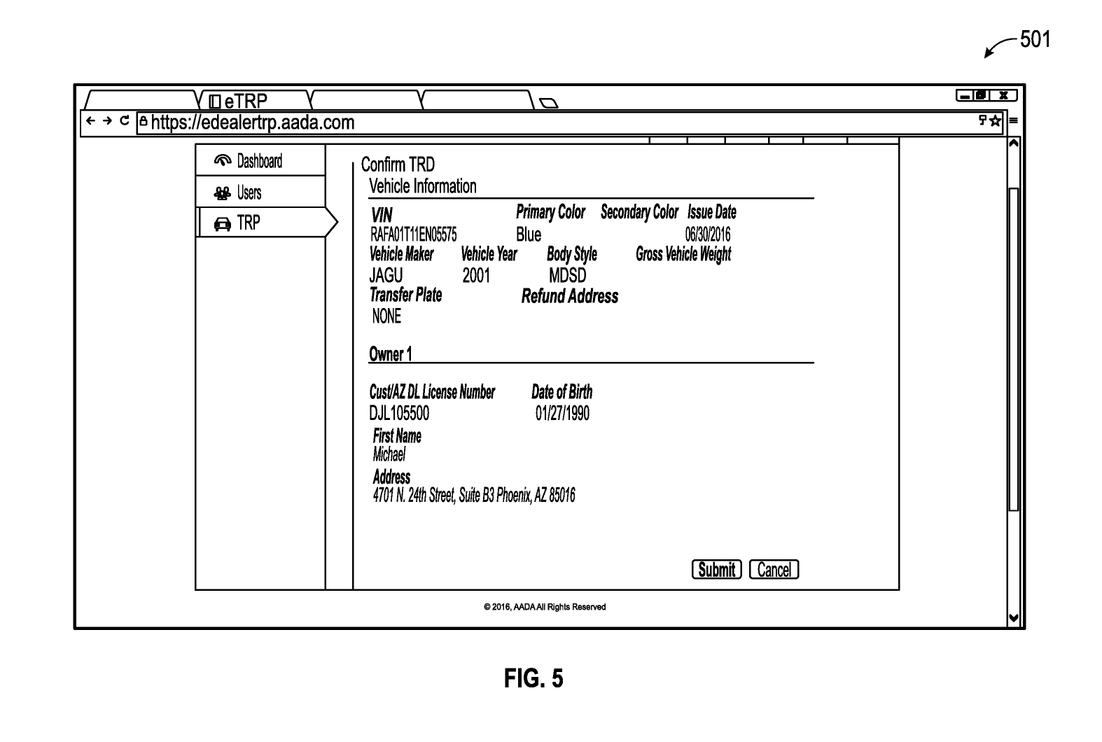

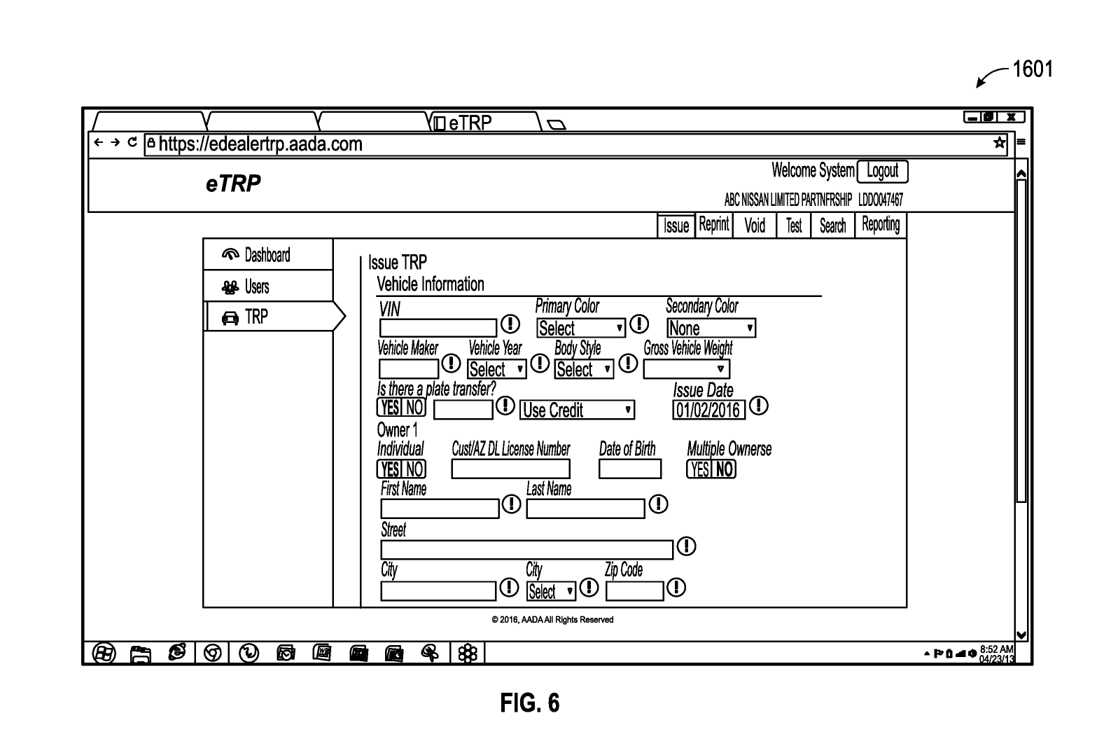

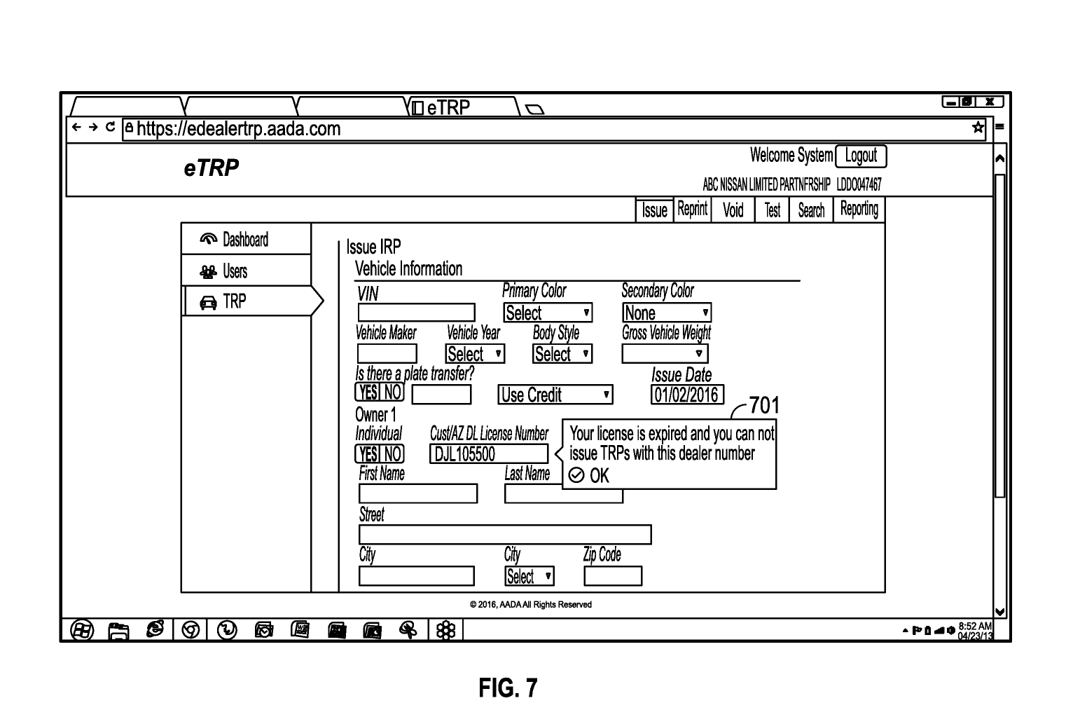

With continued reference to FIG. 4 and also referring now to FIG. 5, when the vehicle information section and owner information section are determined to be correct, the dealer finance clerk may click a “submit” button 421 to reveal a “confirm TRP” screen 501. Alternatively, hovering the cursor over the submit button may highlight or superimpose the data to be confirmed as shown in FIG. 6, so that the MVD database may be updated and the TRP revealed and/or printed in a single click of the “submit” button 421. In so doing, the MVD database is updated (for a previously registered or permitted vehicle) or a new record is instantiated (if not previously registered) and a TRP number is assigned by MVD directly or taken from a block of numbers allocated to the fiduciary. When the dealer finance clerk submits the request for a TRP, the TRP number may be appended to the data file being sent to MVD, along with a dealer license number which may be displayed or transparent to the user. In this regard, an error message 701 (See FIG. 7) may be displayed advising the user that the dealer license number is expired or otherwise invalid, and must be corrected in order for the TRP to issue.

Upon submitting the eTRP request to MVD, MVD creates a new vehicle record (for new vehicles), or updates the existing vehicle record (e.g., when the customer is purchasing a previously registered vehicle which was previously obtained by the dealer from another source), rendering the old plate number “prior” and making the new TRP number “current” for that vehicle record. in this regard, for multi-state usage, the eTRP application may include a state-by-state look up table to determine whether the particular state in question is a “plate goes with owner” or “plate goes with vehicle” state, and process the TRP accordingly.

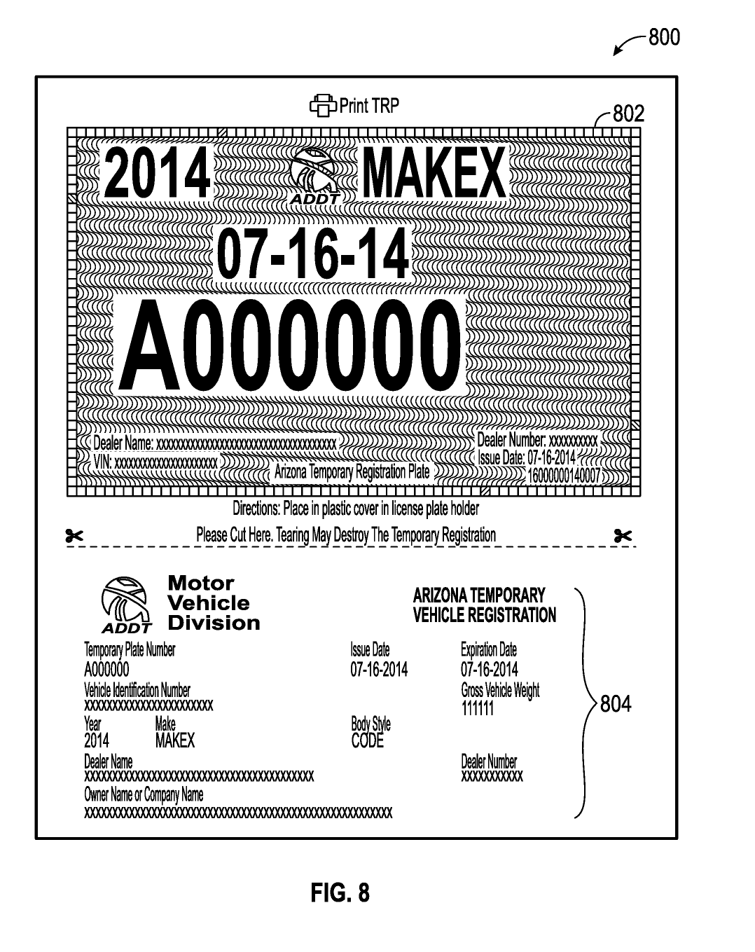

Referring now to FIG. 8, the eTRP application includes code corresponding to a TRP template Boo including a TRP section 802 and a temporary registration section 804, onto which the foregoing data is printed by the printer 206 (FIG. 2).

Those skilled in the art will appreciate that dealers are motivated to get the customer into the newly purchased vehicle and off the lot, even if for some reason the DMV mainframe or internet connection is not functioning properly. Hence, the eTRP application may include a store and forward facility. More particularly, if the MVD database is temporarily inaccessible, the dealer finance clerk may enter the available vehicle and owner information (including make, model, year, color, VIN, driver's license number, name, address, and plate number) and print the TRP, subject to calling it back if the MVD database subsequently reveals a problem with the TRP after the MVD database comes back online.

In an embodiment, the foregoing store and forward facility may be invoked on a record-by-record basis each time the eTRP application attempts to but is unable to access or update MVD database records. That is, the store and forward capability is only invoked on an “as needed: basis, as opposed to prior art systems in which store and forward was invoked when it was determined that MVD access was unavailable, and left on until it was later determined that MVD access was restored. Rather, in accordance with the present invention, the eTRP application continues to ping the MVD database until it is again available. Consequently, the eTRP application of the present invention only stores (for later forwarding) those records that have been affirmatively rejected.

Those skilled in the art will also appreciate that VINs do not include the alphabet letter “O;” as such, a character that resembles an alphabet letter “O” is actually a zero. Accordingly, in one aspect of the present invention, VIN characters mistakenly entered as the letter “O” are auto-corrected to the digit zero, either with or without displaying an explanatory notice to the use (e.g., “VINs do not have Os so we changed it to a zero for you”). This feature may be implemented in real time while the VIN is being keyed in, or algorithmically in near real time after an entire VIN is pasted into the VIN field from another location.

III. eTitle

As described above, the dealer finance clerk processes a TRP for each purchased vehicle using the eTRP application. Thereafter, the dealer title clerk logs onto the eTitle application to begin the process of titling a batch of funded deals, i.e., vehicles which have been paid for or for which funding has been approved by or received from a lender. The eTitle application facilitates obtaining a title and “permanent” registration (as opposed to a temporary registration) for newly purchased new and used vehicles. In this context, a title identifies the owner of the vehicle, whereas the registration defines who has registered vehicle for operation within a particular state.

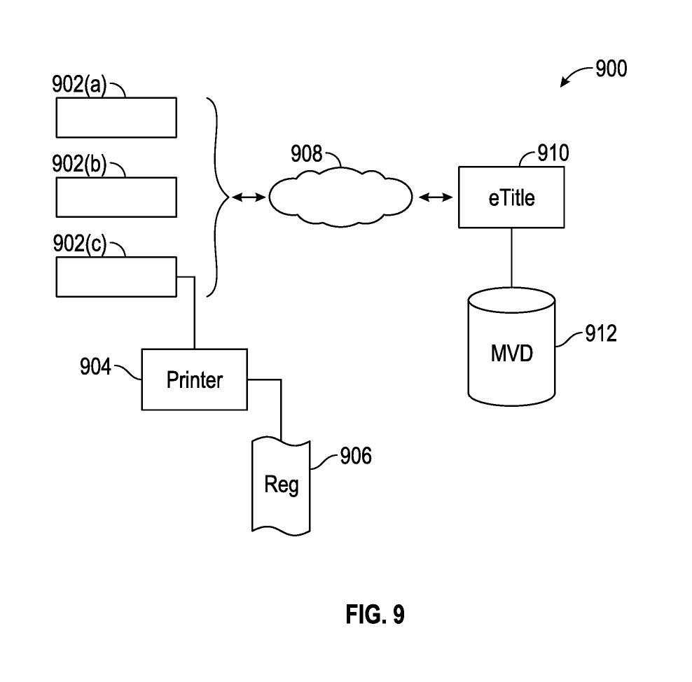

Referring now to FIG. 9, a “many-to-one” hub configuration 900 includes a plurality of dealer computers 902 equipped with a printer 904 for printing a registration document 906 and configured to communicate over a network (e.g., the internet) 908 with a fiduciary 910 which supports an eTitle application portal configured to securely communicate with an MVD database 912.

In a preferred embodiment, the dealer's DMS system is used to assemble funded deals for a predetermined date range (e.g., weekly) into a batch file which is exported from the DMS system into the fiduciary's eTitle application. The dealer title clerk may then logs onto an eTitle portal to begin processing the files on a deal by deal (vehicle by vehicle) basis. The batch file of funded deals may be comma delimited, semi-colon delimited, or in the form of an Excel-type spreadsheet or other suitable format.

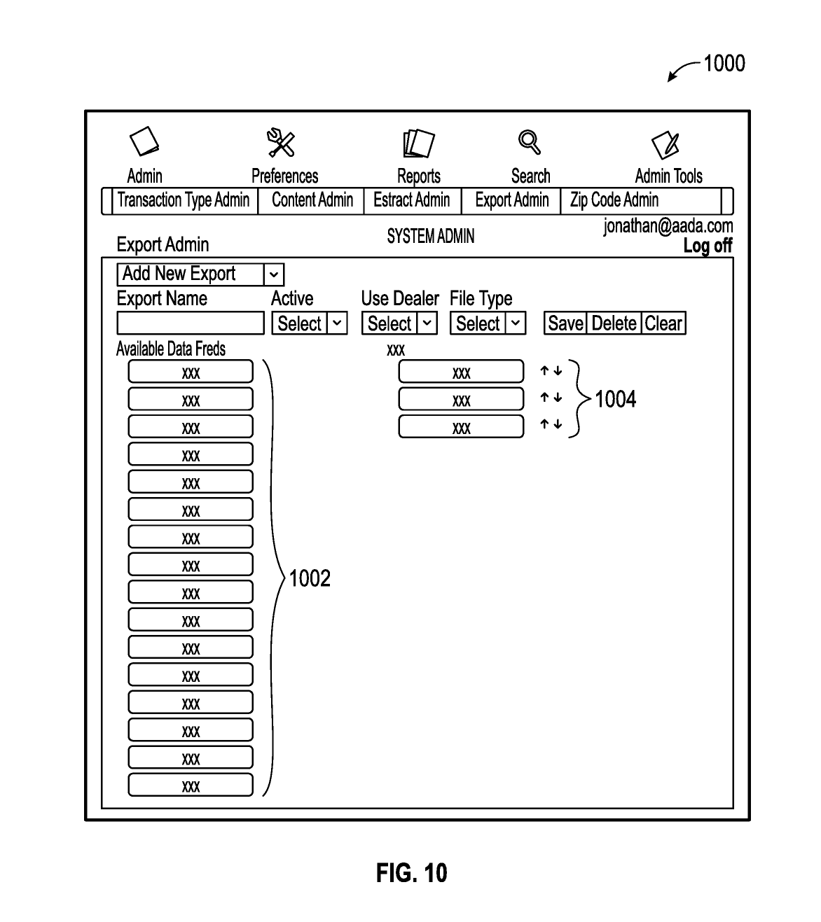

Referring now to FIG. 10, the “funded deal” data may comprise a spreadsheet with each row dedicated to a single vehicle, and the various columns 1002 configurable to include the VIN, customer driver's license number, vehicle make, model, year, date sold, etc. The batch file received from the dealer may contain more fields than the eTitle application needs to process the title and registration. Consequently, a administrative tool such as shown in web page 1000 may be employed to configure (map) the incoming columns 1002 to a subset of columns 1004 needed to process and obtain title and registration documents. In this way, if the dealer changes file configuration, the tool 100 may be used to re-map the incoming batch files to a desired configuration so that they can be parsed and plugged into the eTitle database structure for processing.

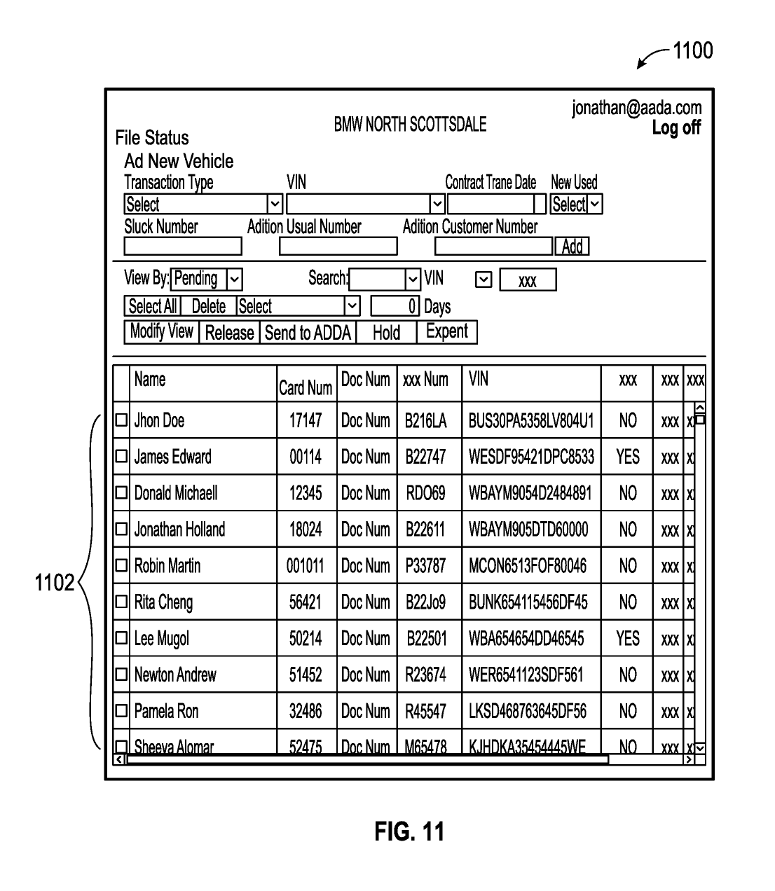

FIG. 11 is a screen shot 1100 showing an exemplary list 1102 of funded deals as viewed by a dealer title clerk through the eTitle portal. The eTitle application populates the various fields in the eTitle GUI using this data. The title clerk then drills into each funded deal, one at a time, and prepares it for title and registration by clicking on one of the vehicles in in the list 1102 to reveal the details of a particular deal.

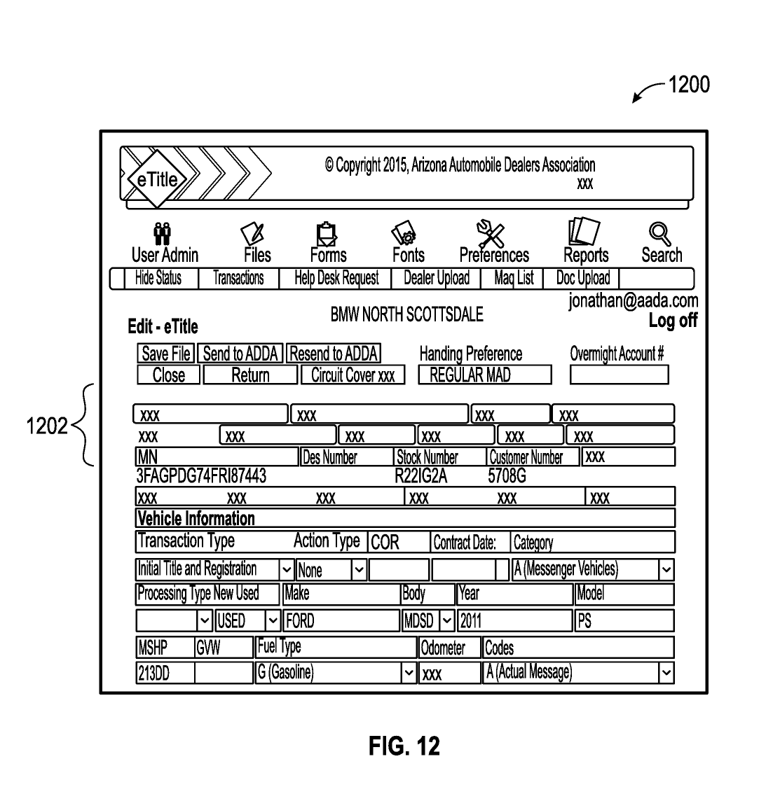

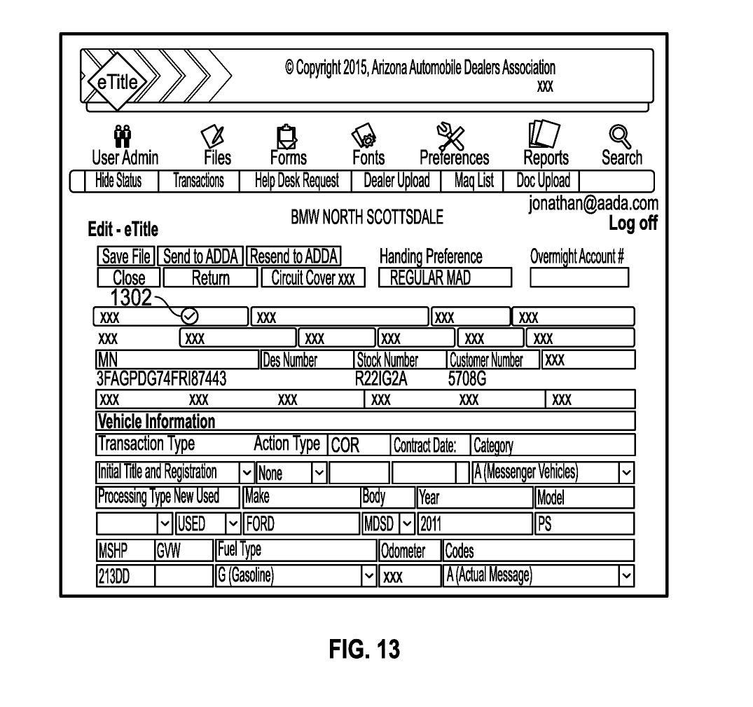

Referring now to FIG. 12, a screen shot 1200 includes a plurality of tabs 1202, each comprising a plurality of data fields associated with an application for title and registration for a vehicle. In a preferred embodiment, when a title clerk is preparing the vehicle data, each time a new tab is pressed or the back key is pressed, the information in the previous tab is saved—on a tab-by-tab basis. With momentary reference to FIG. 13, if there is missing data or an error in a data field associated with a tab, a check mark 1302 or other indicia alerts the user to fix that tab. In contrast, prior art systems required all tabs to be completed before any of the vehicle information could could be saved, using a less efficient global save paradigm. The present approach of saving each tab to the server is more granular, making dealer title clerks and fiduciary processors more efficient at the tedious, data intensive task of applying for title and registration.

In a further embodiment, the eTitle application may employ an intuitive color scheme where, for example, a green check mark on a tab means that the associated data on the tab is valid and saved; a yellow check means the data fields associated with a tab are not yet fully populated, and a red check indicates that the tab contains one or more errors. This yields a global visual view of which tabs need attention even with the tabs closed.

When each funded vehicle record is fully prepared and verified, the title clerk uploads scanned collateral documents and the eTitle application appends them to each vehicle file. Once the scanned documents are uploaded, the entire file is exported to the fiduciary via the eTitle portal.

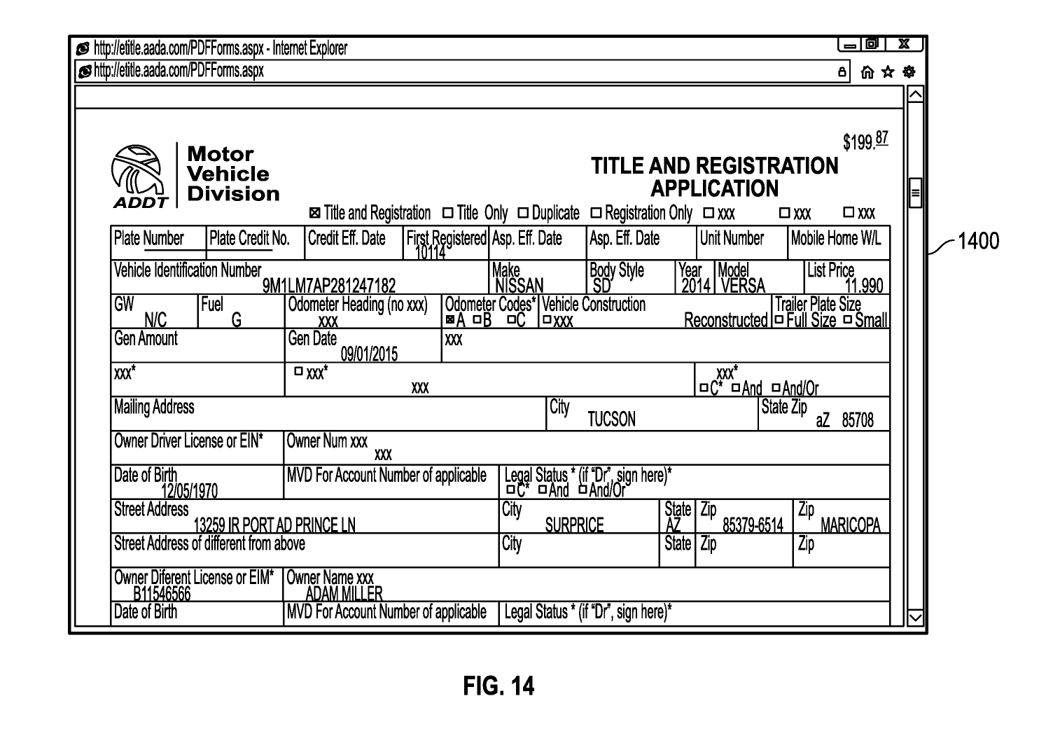

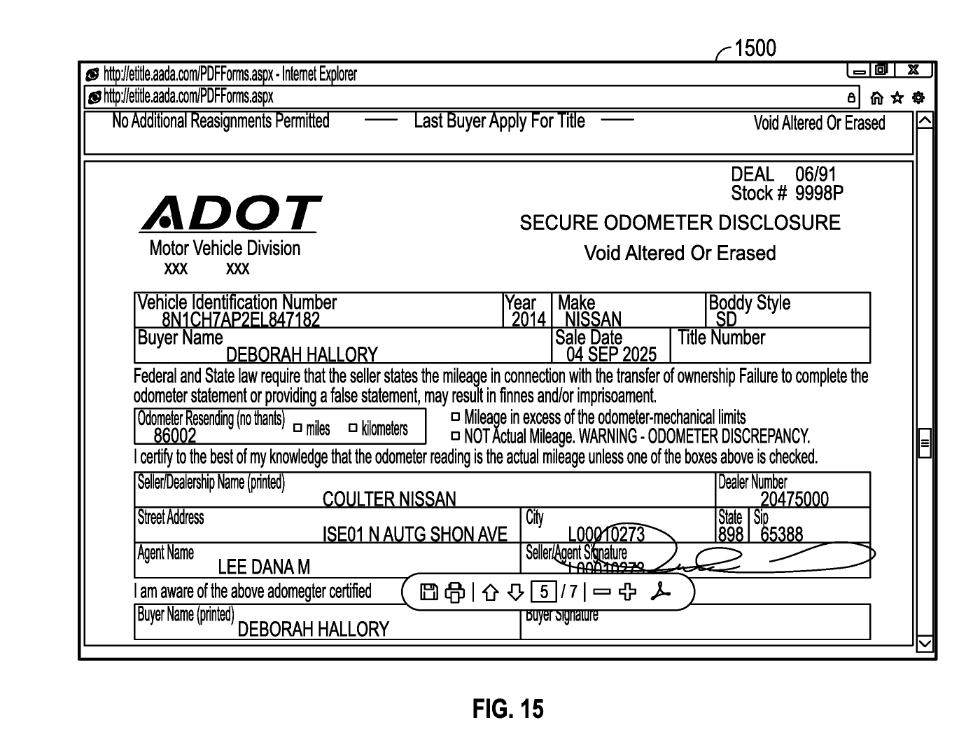

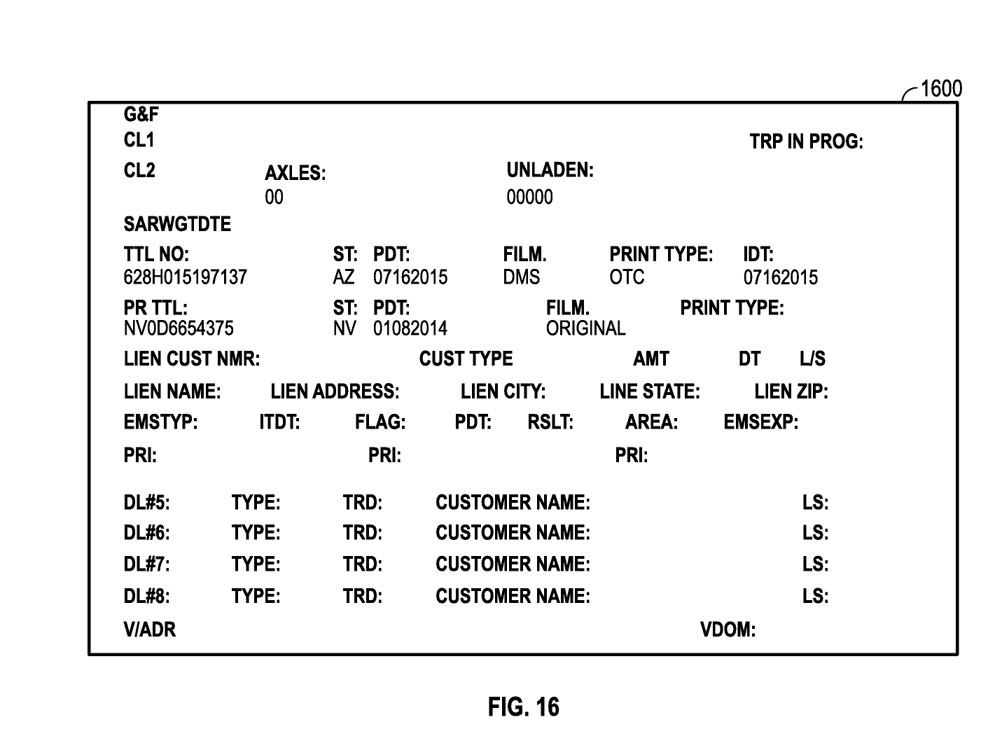

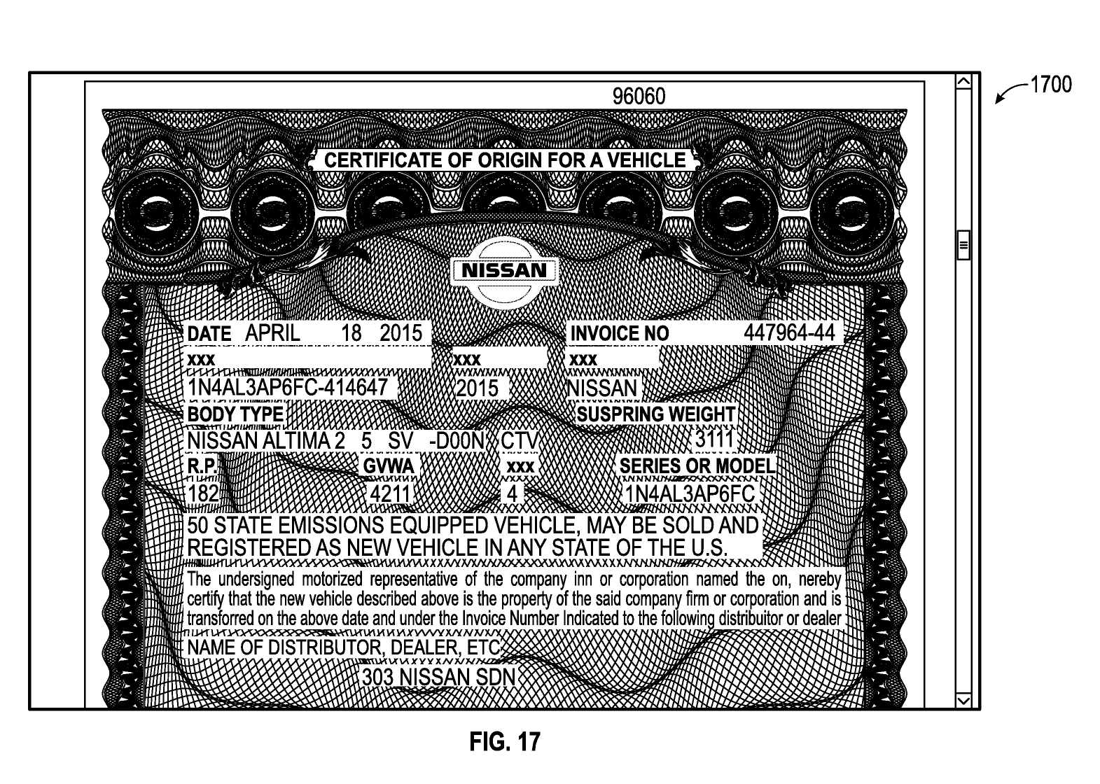

More particularly, the aforementioned collateral documents generally correspond to or otherwise involve forms which the customer fills out at the dealer at the time of purchase, and are calculated to elicit all information needed to populate the eTitle application. Typical collateral documents may include any combination of the following: i) a title and registration application 1400 signed by the purchaser (FIG. 14); ii) a title signed by a previous owner of the vehicle being purchased; iii) secure odometer disclosure 1500 (FIG. 15); iv) a screen scrape snapshot 1600 of MVD data for the vehicle prior to the current sale (FIG. 16); and v) a certificate of origin 1700 (FIG. 17).

Once the application for title and registration and collateral documents are provided to the fiduciary, the dealer's role is complete and the fiduciary becomes the custodian of the electronic files, and a fiduciary processing clerk (“processor”) undertakes final processing before submitting the file to MVD. In particular, the processor checks the accuracy and completeness of the information, updates the MVD mainframe via a secure internet portal, prints the new registration, and mails the registration and a new license plate to the owner. At this stage, the vehicle record is considered fully grown up and reflects the TRP number as “prior”, and the new license plate number (selected in sequence by the fiduciary processor from a physical stack of plates) is designated as “current.”

If no lien exists, the title may be printed and mailed to the owner by either the fiduciary or MVD. If there is a lien, the lien is recorded in the MVD database, an electronic lien is created for the lien holder, and no title is printed at this time (except for limited circumstances such as leased vehicles, in which case the lender may request a printed title). At the end of a predetermined time period, for example, nightly, MVD creates a batch file of liens to be uploaded to the ELT application for subsequent processing, as described in greater detail below.

IV. ELT

The electronic lien and title (ELT) application of the present invention facilitates service provider access to an MVD database in much the same way that the eTRP application provides dealer access to an MVD database. That is, the back end of the ELT system directly and securely accesses MVD data files of lien-related transactions for various states; the front end of ELT comprises a user interface for displaying lien-related information to service providers.

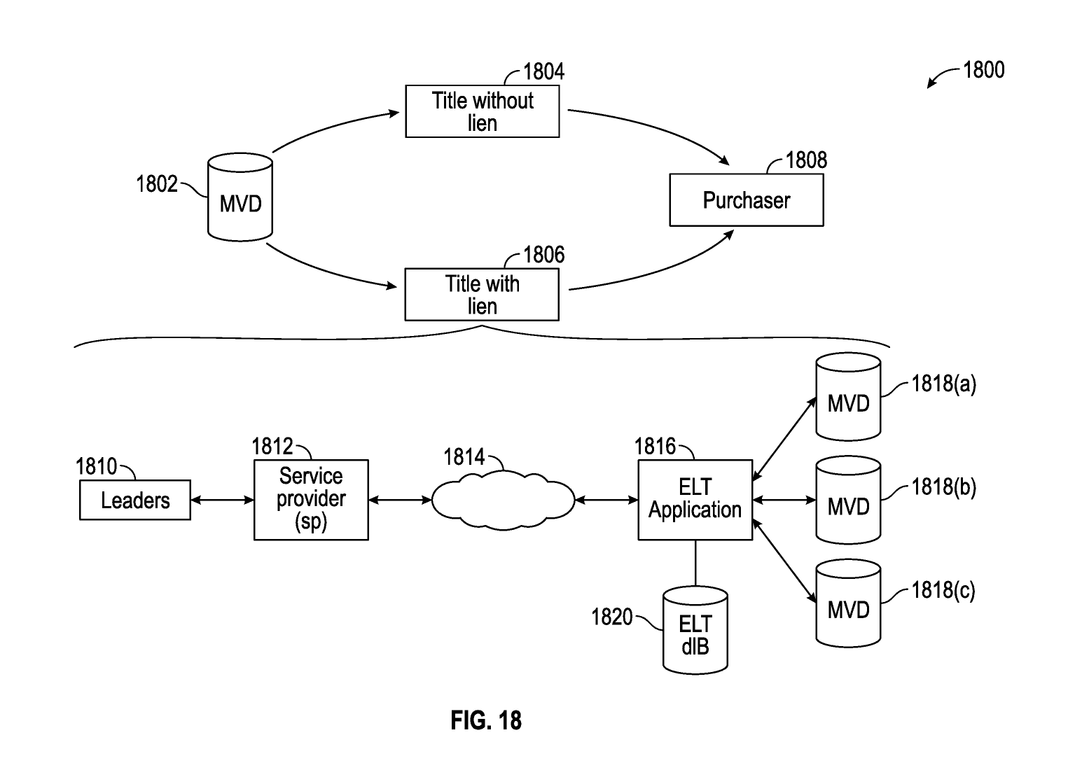

Referring now to FIG. 18, a schematic flow diagram 1800 illustrates how a title without a lien 1804 may sent directly to a purchaser 1808, whereas a title with a lien 1806 typically requires that the lien be satisfied (paid off) before the lien is released and the title sent to the purchaser. More particularly, “many-to-few-to-one” configuration includes a large number of dealers 1810, each under contract with one of a smaller number of lien service providers (SPs) 1812 to interact with MVD on behalf of the lender. In an exemplary embodiment, each SP 1812 is configured to communicate over a network (e.g., the internet) 1814 with a fiduciary 1816 which supports an ELT application portal having an associated ELT database 1820 and configured to securely communicate with one or more state MVD databases 1818. In an embodiment, the disaster recovery server for a first state's MVD may be located in, for example, a second state, and the disaster recovery server for the second state may be in the first state.

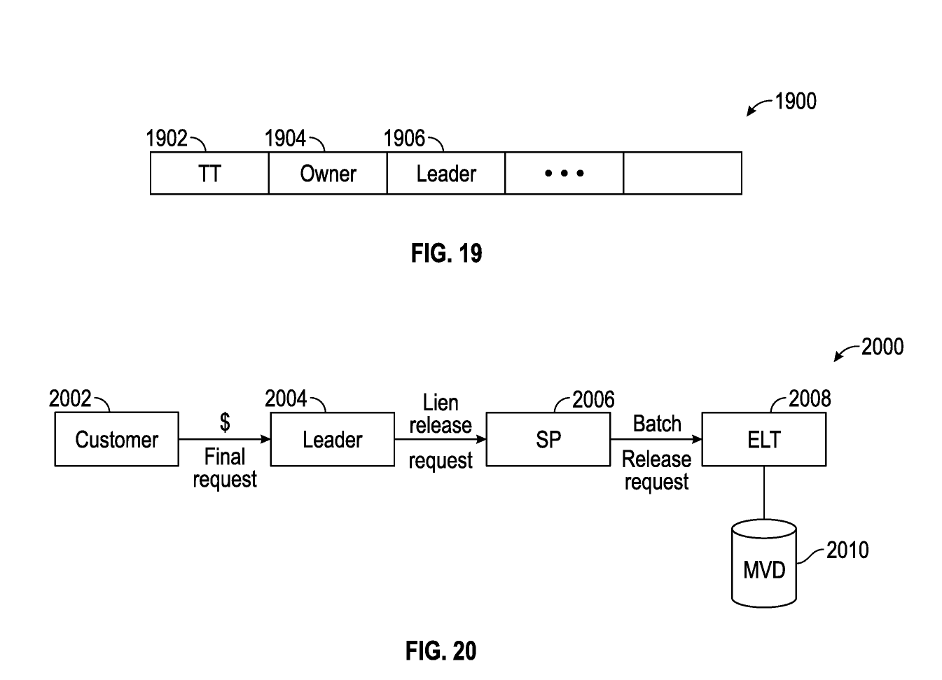

With continued reference to FIG. 18 and also referring now to FIG. 19, an exemplary transaction message 1900 for transmission between a service provider and an MVD includes a transaction type (TT) field 1902, an owner field 1904, a lender field 1906, and other information associated with a title bearing a lien. The ELT database 1820 suitably maintains a look up table of all lenders and their corresponding service providers to facilitate message routing. The recording of the lien, typically as a result of a title and registration being processed, triggers a message from MVD to the lender (via the service provider) with a transaction type indicating that a lien has been recorded.

More generally, each MVD periodically assembles a batch of recorded liens and sends the batch to the fiduciary 1816, whereupon the fiduciary parses the messages into sub-batches for transmission to the various service providers under contract with the fiduciary (the single “hub” in the many-to-few-to-one configuration). The service providers then report the liens to the various lenders. States increasingly require a lender to engage a service provider in order to record liens in the MVD database.

In the embodiment shown in FIG. 18, the state periodically (e.g., daily) uploads (“pushes”) batch files of recorded liens to a secure server, for example, a file transfer protocol (FTP) server or a secure file transfer protocol (SFTP) server, from which the fiduciary, using the ELT application, periodically (e.g., daily) retrieves (“pulls”) the files. Alternatively, the push/pull can be inverted or any combination of dedicated or non-dedicated secure file transfers may be employed.

With continued reference to FIGS. 18 and 19, the other principal transaction types handled by the ELT application in addition to the aforementioned lien recording notification message involve a lien release notification, a lien correction request, and a lien “print” request, i.e., printing a title with a lien on it. A lien print request typically arises when, for example, a customer leases a vehicle and moves to a different state, and the leasing company desires to have the vehicle re-titled in the new state with the same lien.

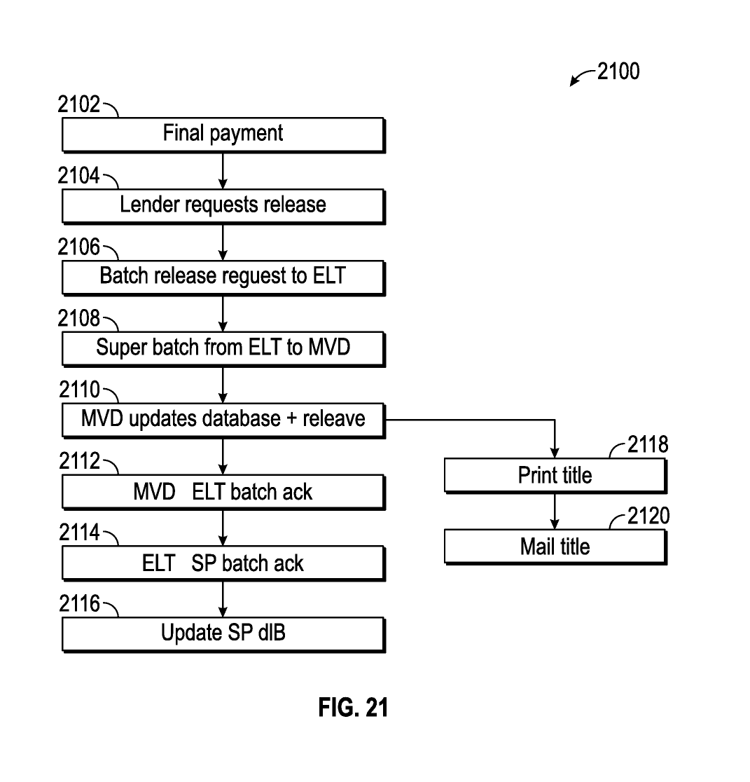

Referring now to FIGS. 20 and 21, the manner in which a lien release is processed in accordance with an exemplary embodiment will now be described.

More particularly, FIG. 20 illustrates a “many-to-few-to-one” configuration 2100 including a large number of lenders 2004 each under contract with one of a smaller number of service providers 2006, where each lender has at least one customer 2002 and each SP 2006 is configured to communicate with an MVD database 2010 via an ELT portal 2008.

FIG. 21 is a schematic flow diagram 2100 of a typical lien release process. In particular, after a customer 2002 makes a final loan payment or the loan underlying the lien is otherwise paid off (Task 2102), the lender transmits a lien release request to the SP (Task 2104). Each SP periodically (e.g., hourly, nightly) sends a batch file of lien release requests to the fiduciary (Task 2106). The fiduciary then sends a super-batch file, including batch requests from several SPs, to be processed by the MVD database (Task 2108).

With continued reference to FIG. 21, MVD then updates its database to reflect the lien releases. In a preferred embodiment, the MVD prints a paper title (Task 2118) reflecting the released lien (or reflecting no lien at all), and mails the clean title to the vehicle owner (Task 2120). Alternatively, the fiduciary may print and mail the title.

Once the MVD database is updated to reflect the released liens, MVD sends a batch confirmation/acknowledgement to the fiduciary (Task 2112), whereupon the fiduciary sends a batch confirmation/acknowledgement to each SP (Task 2114). The SP records are then updated to confirm the lien releases.

The third transaction type involves printing a title which has a lien associated with the underlying vehicle. More particularly, the lender or service provider may route a request for a printed title bearing a lien through the fiduciary, for example, when the owner of a vehicle subject to a lien desires to sell the vehicle or obtain a title in a different state. Either MVD or the fiduciary can print the title once the MVD database is updated to reflect the change from an electronic to a paper title.

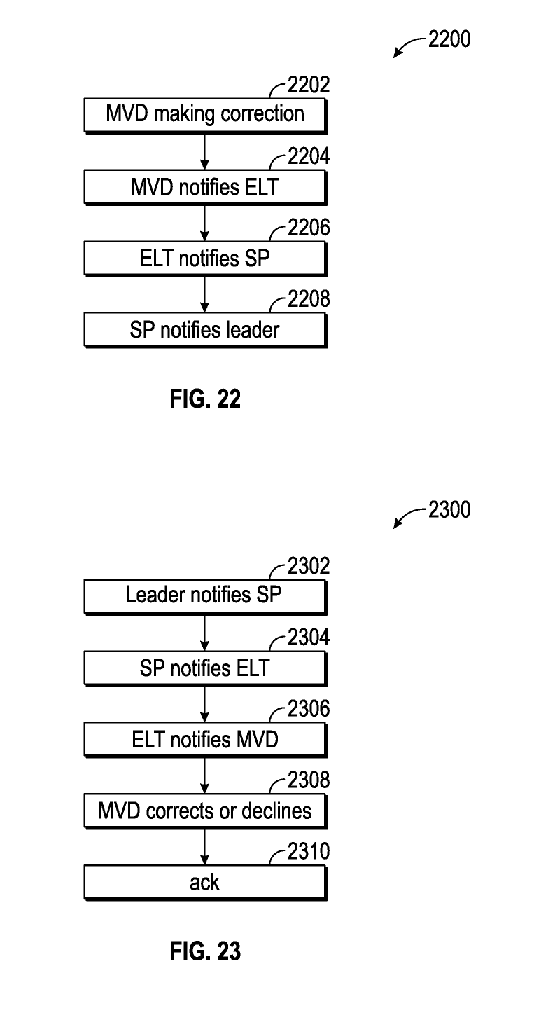

Referring now FIG. 22, a process 2200 for correcting an electronic title bearing a lien initiated by an MVD includes MVD correcting the title (Task 2202), transmitting a correction confirmation message to the fiduciary (Task 2204), whereupon the fiduciary notifies the SP (Task 2206) and the SP notifies the lender (Task 2208).

Referring now FIG. 23, a process 2300 for correcting an electronic title bearing a lien initiated by a lender, for itself or on behalf of the vehicle owner, includes sending a correction request from the lender to the SP (Task 2302), forwarding the correction request from the SP to the fiduciary (Task 2304), transmitting a correction message form the fiduciary to MVD (Task 2306), whereupon MVD either makes the correction or declines to do so (Task 2308). MVD then reflects back its decision to the lender via the fiduciary and SP (Task 2310).

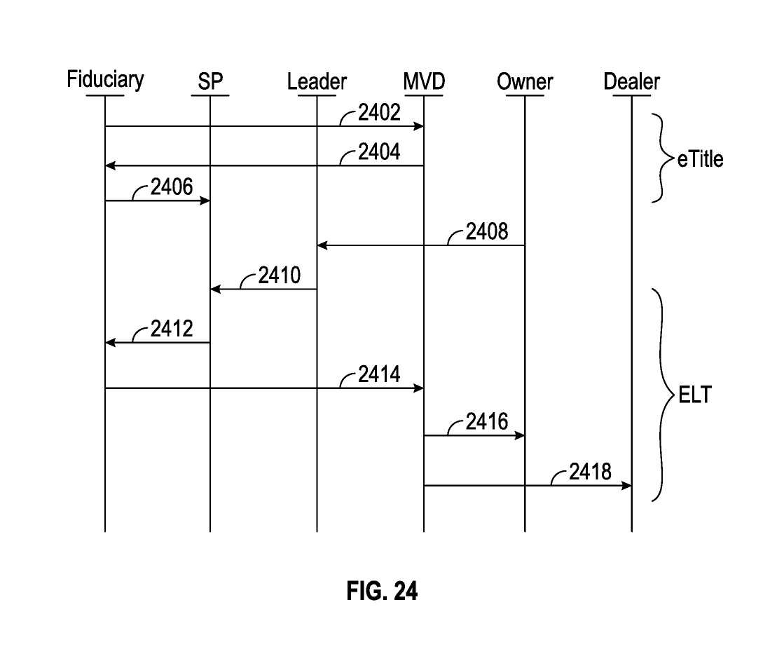

Referring now to FIG. 24, a sequence diagram 2400 illustrates the life of a lien from initial recording to lien release. More particularly, an authorized fiduciary initially records the lien in the MVD database (Event 2402). The fiduciary then confirms the lien recordation in the fiduciary database (Event 2404), and provides the lien details to the appropriate SP (Event 2406).

After a period of time the owner makes the final loan payment to the lender (Event 2408), whereupon the lender notifies the SP that the lien has been satisfied (Event 2410). The SP then sends a lien release request to the fiduciary (Event 2412), whereupon the lien is released using the protocols discussed above in connection with FIGS. 20 and 21 (Event 2414). A clean title may then be mailed to the owner (Event 2416) or, alternatively, to a dealer or other third party, for example, in connection with a trade-in (Event 2418).

As used herein, the word “exemplary” means “serving as an example, instance, or illustration.” Any implementation described herein as “exemplary” is not necessarily to be construed as preferred or advantageous over other implementations.

A method is thus provided for controlling dealer access to a temporary registration permit (TRP) portal hosted by a fiduciary on behalf of a state motor vehicle department (MVD). The method includes the steps of: providing periodic updates from the MVD to the fiduciary including a list of currently valid dealer licenses; logging onto the portal by a first dealer; providing, by the first dealer, a first dealer license number to the fiduciary; determining, by the fiduciary, if the first dealer license number is on the list of currently valid dealer licenses; granting access to the TRP portal to the first dealer if the first dealer license number is on the list of currently valid dealer licenses; and denying access to the TRP portal to the first dealer if the first dealer license number is not on the list of currently valid dealer licenses.

In an embodiment, periodically may mean daily, approximately hourly, or any other desired period.

A method is also provided for issuing a temporary registration permit (TRP) by a fiduciary on behalf of a state motor vehicle department (MVD). The method includes: receiving a vehicle identification number (VIN) into a VIN field of a TRP application; automatically retrieving, in response to receiving the VIN, the make, year, and body style corresponding to the VIN from a remote MVD database; and automatically populating the TRP application with the make, year, and body style information.

In various embodiments, receiving the VIN may comprise manually tabbing out of the VIN field, clicking a cursor in a data entry field other than the VIN field, or receiving the Nth character of the VIN, where N is an integer number of characters which the TRP application recognizes as a complete VIN. In an embodiment, N=17.

A method is further provided for issuing a temporary registration permit (TRP) by a fiduciary operating a TRP application on behalf of a state motor vehicle department (MVD). The method includes: determining that an existing license plate is to be transferred to a purchased vehicle; receiving driver's license number and date of birth (DOB) information for the purchaser of the vehicle; automatically retrieving, in response to receiving the driver's license number and DOB, an existing plate number associated with the driver's license number and DOB from a remote MVD database; and automatically populating a plate number field of the TRP application with the existing plate number.

In an embodiment the method further includes retrieving from the MVD database the plate credit associated with the existing plate number.

In an embodiment the method further includes prompting a user of the TRP application to select how the plate credit is to be used.

In an embodiment, prompting comprises presenting a drop down menu including at least the following options: apply the plate credit to a new plate for the purchased vehicle; and refund the plate credit to the purchaser.

In an embodiment, prompting comprises asking if the purchaser desires to transfer the existing plate number to the vehicle being purchased even if no plate credit is available.

In an embodiment, the method further includes: automatically retrieving from the MVD database, in response to a change in one of the driver's license number and DOB, a different plate number.

In an embodiment, the method further includes: receiving a manually entered existing plate number; automatically retrieving from the MVD database, in response to receiving the manually entered existing plate number, plate credit information associated with the existing plate number; and displaying the plate credit information.

In an embodiment, the method further includes: automatically retrieving, in response to receiving the driver's license number and DOB, name and address information associated with the driver's license number and DOB from a remote MVD database; and automatically populating name and address fields of the TRP application with the name and address information.

In an embodiment, the method further includes: automatically retrieving, in response to receiving the driver's license number and DOB, multiple existing plate numbers associated with the driver's license number and DOB from a remote MVD database; and prompting a user to select at least one of the multiple existing plate numbers.

A method is further provided for issuing a temporary registration permit (TRP) by a fiduciary operating a TRP application on behalf of a state motor vehicle department (MVD). The method includes: displaying a vehicle information section including a first plurality of data fields on a top portion of a graphical user interface (GUI) screen; and displaying an owner information section including a second plurality of data fields on a second portion of the same GUI screen; wherein the vehicle information section and the owner information section are simultaneously displayed above the fold.

In an embodiment, the first plurality of data fields comprises a VIN field and a color field, and the second plurality of data fields comprises a driver's license number field and a DOB field.

In an embodiment, the method further includes: upon the VIN, color, driver's license number, and DOB fields being populated, displaying a submit button; and upon selection of the submit button, updating the MVD records in accordance with the first and second plurality of fields and effecting the printing of the TRP pursuant to a single click operation.

In an embodiment, the method further includes: upon the submit button being hovered over by a cursor, displaying the first and second plurality of fields; and prompting a user to confirm the accuracy of the first and second plurality of fields.

In an embodiment, the method further includes: creating, in a remote MVD database, a new vehicle record comprising at least the VIN, color, driver's license number, and DOB information.

In an embodiment, the method further includes: updating, in a remote MVD database, an existing vehicle record to reflect at least the VIN, color, driver's license number, and DOB information, and replacing the plate number associated with the existing vehicle record with a new TRP number.

In an embodiment, the method further includes updating the MVD records to reflect a TRP number drawn from a block of preassigned numbers maintained by the fiduciary.

In an embodiment, the method further includes: upon the VIN, color, driver's license number, and DOB fields being populated, displaying a submit button; upon selection of the submit button, detecting a communication error associated with a remote MVD database; and in response to detecting the communication error, enabling a store and forward facility for the then current TRP submission only.

In an embodiment, the method further includes: periodically pinging the MVD database to determine that the communication error is abated; and in response to abatement of the communication error, submitting the stored TRP submission to the MVD.

In an embodiment, the method further includes issuing a temporary permit pending abatement of the communication error.

In an embodiment, the method further includes revoking the temporary permit following abatement of the communication error.

A method is further provided for issuing a temporary registration permit (TRP) by a fiduciary on behalf of a state motor vehicle department (MVD). The method includes: receiving a vehicle identification number (VIN) into a VIN field of a TRP application; detecting a letter “O” in the VIN field; and automatically replacing the letter “O” with the number zero.

In an embodiment, the method further includes displaying a message indicating that the letter “O” was automatically replaced with the number zero.

An integrated computer software program is further provided. The program comprises a single block of computer code stored in a non-transient medium and operated by a fiduciary on behalf of an MVD and which, when executed by a computer processor, updates a vehicle record maintained in an MVD database through the steps of: issuing a temporary registration permit (TRP) at a dealer; issuing a title and a registration at a fiduciary; recording a lien associated with the title; and releasing the lien.

A method is further provided for processing an application for vehicle title and registration. The method includes: displaying a plurality of tabs each comprising a plurality of fields relating to a vehicle and an owner; saving information entered into the fields to a remote server when all fields associated with a particular one of the tabs is completed, but not before all the fields associated with the particular one of the tabs is completed.

In an embodiment, the method further includes displaying visual indicia adjacent each tab for which a field is incomplete, the visual indicia alerting a user to complete the missing field

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed:

1. A method performed by a computer system for controlling dealer access to a temporary registration permit (TRP) portal hosted by a fiduciary on behalf of a state motor vehicle department (MVD), comprising the steps of:
providing periodic updates from the MVD to the fiduciary including a list of currently valid dealer licenses;
logging onto the portal by a first dealer;
providing, by the first dealer, a first dealer license number to the fiduciary;
determining, by the fiduciary, if the first dealer license number is on the list of currently valid dealer licenses;
granting access to the TRP portal to the first dealer if the first dealer license number is on the list of currently valid dealer licenses; and
denying access to the TRP portal to the first dealer if the first dealer license number is not on the list of currently valid dealer licenses.

2. The method of claim 1, wherein periodically comprises one of daily and approximately hourly.

3. A method performed by a computer system for issuing a temporary registration permit (TRP) by a fiduciary on behalf of a state motor vehicle department (MVD), comprising the steps of:
receiving a vehicle identification number (VIN) into a VIN field of a TRP application;
automatically retrieving, in response to receiving the VIN, the make, year, and body style corresponding to the VIN from a remote MVD database; and
automatically populating the TRP application with the make, year, and body style information.

4. The method of claim 3, wherein receiving comprises manually tabbing out of the VIN field.

5. The method of claim 3, wherein receiving comprises clicking a cursor in a data entry field other than the VIN field.

6. The method of claim 3, wherein receiving comprises receiving the Nth character of the VIN, where N is an integer number of characters which the TRP application recognizes as a complete VIN.

7. The method of claim 6, where N=17.

8. A method performed by a computer system for issuing a temporary registration permit (TRP) by a fiduciary operating a TRP application on behalf of a state motor vehicle department (MVD), comprising the steps of:
determining that an existing license plate is to be transferred to a purchased vehicle;
receiving driver's license number and date of birth (DOB) information for the purchaser of the vehicle;
automatically retrieving, in response to receiving the driver's license number and DOB, an existing plate number associated with the driver's license number and DOB from a remote MVD database; and
automatically populating a plate number field of the TRP application with the existing plate number.

9. The method of claim 8, further comprising retrieving from the MVD database the plate credit associated with the existing plate number.

10. The method of claim 9, further comprising prompting a user of the TRP application to select how the plate credit is to be used.

11. The method of claim 10, wherein prompting comprises presenting a drop down menu including at least the following options:
apply the plate credit to a new plate for the purchased vehicle; and
refund the plate credit to the purchaser.

12. The method of claim 10, wherein prompting comprises asking if the purchaser desires to transfer the existing plate number to the vehicle being purchased even if no plate credit is available.

13. The method of claim 8, further comprising:
automatically retrieving from the MVD database, in response to a change in one of the driver's license number and DOB, a different plate number.

14. The method of claim 8, further comprising:
receiving a manually entered existing plate number;
automatically retrieving from the MVD database, in response to receiving the manually entered existing plate number, plate credit information associated with the existing plate number; and
displaying the plate credit information.

15. The method of claim 8, further comprising:
automatically retrieving, in response to receiving the driver's license number and DOB, name and address information associated with the driver's license number and DOB from a remote MVD database; and
automatically populating name and address fields of the TRP application with the name and address information.

16. The method of claim 8, further comprising:
automatically retrieving, in response to receiving the driver's license number and DOB, multiple existing plate numbers associated with the driver's license number and DOB from a remote MVD database; and
prompting a user to select at least one of the multiple existing plate numbers.

17. A method performed by a computer system for issuing a temporary registration permit (TRP) by a fiduciary operating a TRP application on behalf of a state motor vehicle department (MVD), comprising the steps of:
displaying a vehicle information section including a first plurality of data fields on a top portion of a graphical user interface (GUI) screen; and
displaying an owner information section including a second plurality of data fields on a second portion of the same GUI screen;
wherein the vehicle information section and the owner information section are simultaneously displayed above the fold.

18. The method of claim 17, wherein the first plurality of data fields comprises a VIN field and a color field, and the second plurality of data fields comprises a driver's license number field and a DOB field.

19. The method of claim 18, further comprising:
upon the VIN, color, driver's license number, and DOB fields being populated, displaying a submit button; and
upon selection of the submit button, updating the MVD records in accordance with the first and second plurality of fields and effecting the printing of the TRP pursuant to a single click operation.

20. The method of claim 19, further comprising:
upon the submit button being hovered over by a cursor, displaying the first and second plurality of fields; and
prompting a user to confirm the accuracy of the first and second plurality of fields.

21. The method of claim 19, further comprising:
creating, in a remote MVD database, a new vehicle record comprising at least the VIN, color, driver's license number, and DOB information.

22. The method of claim 19, further comprising:
updating, in a remote MVD database, an existing vehicle record to reflect at least the VIN, color, driver's license number, and DOB information, and replacing the plate number associated with the existing vehicle record with a new TRP number.

23. The method of claim 19, further comprising updating the MVD records to reflect a TRP number drawn from a block of preassigned numbers maintained by the fiduciary.

24. The method of claim 18, further comprising:
upon the VIN, color, driver's license number, and DOB fields being populated, displaying a submit button;
upon selection of the submit button, detecting a communication error associated with a remote MVD database; and
in response to detecting the communication error, enabling a store and forward facility for the then current TRP submission only.

25. The method of claim 24, further comprising:
periodically pinging the MVD database to determine that the communication error is abated; and
in response to abatement of the communication error, submitting the stored TRP submission to the MVD.

26. The method of claim 24, further comprising:
issuing a temporary permit pending abatement of the communication error.

27. The method of claim 26, further comprising:
revoking the temporary permit following abatement of the communication error.

28. A method implemented by a computer system for issuing a temporary registration permit (TRP) by a fiduciary on behalf of a state motor vehicle department (MVD), comprising the steps of:
receiving a vehicle identification number (VIN) into a VIN field of a TRP application;
detecting a letter “O” in the VIN field; and
automatically replacing the letter “O” with the number zero.

29. The method of claim 28, further comprising:
displaying a message indicating that the letter “O” was automatically replaced with the number zero.

30. An integrated computer software program comprising a single block of computer code stored in a non-transient medium and operated by a fiduciary on behalf of an MVD and which, when executed by a computer processor, updates a vehicle record maintained in an MVD database through the steps of:
issuing a temporary registration permit (TRP) at a dealer;
issuing a title and a registration at a fiduciary;
recording a lien associated with the title; and
releasing the lien.

31. A method implemented by a computer system for processing an application for vehicle title and registration, comprising:
displaying a plurality of tabs each comprising a plurality of fields relating to a vehicle and an owner; and
saving information entered into the fields to a remote server when all fields associated with a particular one of the tabs is completed, but not before all the fields associated with the particular one of the tabs is completed.

32. The method of claim 31, further comprising:
displaying visual indicia adjacent each tab for which a field is incomplete, the visual indicia alerting a user to complete the missing field.
